(19) United States
(12) Patent Application Publication
(10) Pub. No.: US 2021/0001658 A1
(43) Pub. Date: Jan. 7, 2021

(54) GIFT ARTICLE

(71) Applicant: Brandie Knight McGlinchey, Crestview, FL (US)

(72) Inventor: Brandie Knight McGlinchey, Crestview, FL (US)

(21) Appl. No.: 17/024,511

(22) Filed: Sep. 17, 2020

Related U.S. Application Data
(60) Provisional application No. 62/901,483, filed on Sep. 17, 2019.

(51) Int. Cl. B42D 15/04; B65D 30/20; G09F 1/04

(52) U.S. Cl. CPC B42D 15/045; G09F 1/04; B65D 31/10

(57) ABSTRACT

The present invention is directed to a gift article having a front panel, the front panel, and a rear panel. Each the front panel and the rear panel having an outer face and an inner face. The front panel and the rear panel having a common edge, the common edge configured as a fold line permitting the folding of the first panel against the second panel. The gift article further comprises a gift holder having a front wall and a rear wall, the front wall and the rear wall having at least three edges bonded to form an enclosure, the enclosure having an opening for receiving a gift item, the opening is configured with a fastener for closing access into the interior of the enclosure through the opening.

### CROSS-REFERENCE TO RELATED APPLICATIONS

This application claims priority to the U.S. provisional patent application Ser. No. 62/901,483, filed on Sep. 17, 2019, which is incorporated herein by reference in its entirety.

### FIELD OF INVENTION

The present invention generally relates to a gift article, and particularly the present invention relates to a gift article having an integrated greeting card and a gift holder.

### BACKGROUND

Greeting cards are well-known in the art and their usage can be traced back to the 15^{th} Century. The tradition of giving greeting cards is popular for most of the occasions, including festivities, holidays, birthdays, weddings, Christmas, and Valentine's Day. The greeting cards have been used to express emotions in a more aesthetic manner, for example the greeting can be used to express get well, miss you, and the like messages. The greeting cards are usually constructed with card stock paper, photo paper, cardboard. And like material that can be scored or folded. Moreover, the greetings cards are pre-printed with designs and greetings, such as happy birthday with images of cakes and balloons. The user can write the name of the recipient and optionally a personalized message.

Along with the greeting cards, there is also a tradition of giving gift items. The giver usually gives the intended receiver a greeting card and gift item. In addition, the gift items are usually wrapped in decorative paper or may be placed in decorative gift bags. Perishable gift items such as homemade cookies or homemade candies are typically placed in decorative tin cans or decorative platters covered with a plastic wrap for freshness.

Greeting cards have evolved over the years to improve the functionality to include a gift item by integrating improvements such as a paper pouch, a gift card holder, a money holder, a chocolate bar holder, and record sleeve, among other improvements. For example, U.S. Pat. No. 5,133,496 discloses a combination greeting card and gift pouch constructed with a sheet-like paper or cardboard base consisting of three panels. U.S. Pub. No. US 2015/0279241A1 discloses a gift card presenter for holding a gift card within a greeting card where the holder is constructed of paper and attached inside the greeting card with adhesive. U.S. Pat. No. 8,899,413B2 discloses a combined gift product and chocolate bar greeting card constructed preferably with box stock for a single wrapped chocolate bar, a money holder, and a gift cardholder. U.S. Pat. No. 6,003,254 discloses a combined greeting card and record sleeve in a side-fold design. However, the prior art items as described above are limited to the size, shape, and type of items that can be gifted inside the greeting card. In addition to the greeting card, when giving a gift item that is not flat such as a gift card, money, candy bar, the giver usually uses decorative wrapping paper and tape, a handled gift bag, or decorative tin to conceal the gift. In the instance of the gift pouch described above, the pouch is constructed from sheet-like paper or cardboard with a narrow width that limits the size, shape, and type of gift item that can be enclosed, as well as, the pouch is designed for one-time use.

A need is therefore appreciated for an improved gift article that embodies a greeting card and a versatile gift holder in a unitary structure.

### SUMMARY OF THE INVENTION

The principal object of the present invention is therefore directed to an improved gift article that integrates a versatile gift holder.

It is a further object of the present invention that the gift holder provides for the versatility of the size, shape, and type of gift item that can be given to an intended receiver.

It is an additional object of the present invention that the gift article reduces packaging wastage.

It is another object of the present invention that the gift article is economical to manufacture.

It is another object of the present invention that the gift article reduces the labor and time for packaging a gift.

It is a further object of the present invention that the gift article is reusable.

In one aspect, disclosed is a gift article that embodies a greeting card and a gift holder in a unitary structure. The disclosed gift article allows the versatility of the size, shape, and type of gift item that can be given to an intended receiver. The disclosed gift article eliminates the need for decorative wrapping paper, tape, handled gift bags, tin cans, and like items that conceal the gift from the intended receiver for the element of surprise.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is showing a first panel, a second panel, and a fold line connecting the first panel and the second panel, according to an exemplary embodiment of the present invention.

FIG. 2 is showing another embodiment of the greeting card having the first panel, the second panel, and a margin connecting the first panel and the second panel.

FIG. 3 is showing the gift holder, according to an exemplary embodiment of the present invention.

FIG. 4 shows one implementation of the gift article.

FIG. 5 is a front perspective view of the gift article of FIG. 4.

FIG. 6 shows an implementation of the gift holder configured as a gusset pouch.

FIG. 7 is another implementation of the gift article.

FIG. 8 is a bottom view of another implementation of gift article.

FIG. 9 is showing another implementation of the gift article.

FIG. 10 is a front view of the gift article of FIG. 9.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as devices and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details.

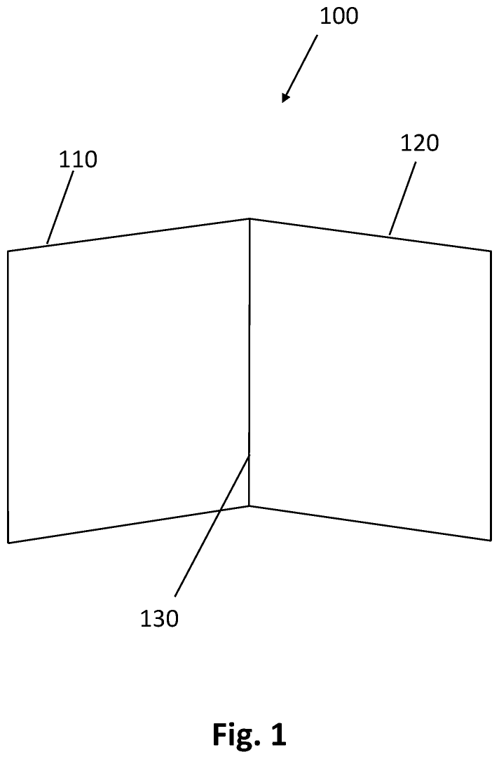

The present invention is directed to a gift article that embodies a greeting card and a gift holder is a unitary structure. The gift article is particularly advantageous by having a versatile gift holder that can be used to carry gifts of assorted sizes and shapes. Now referring to FIG. 1 which shows two panels of the gift article disclosed herein. In one implementation, the gift article includes a first panel 110 and a second panel 120 connected by a fold line 130. The first panel 110 also referred herein as the front panel and the second panel 120, also referred herein as the rear panel can fold towards each other along the fold line 130. FIG. 1 shows an elongated rectangular-shaped sheet 100 that is having a traversing fold line 130 dividing the sheet into two halves i.e. the first panel and the second panel. The sheet for the gift article disclosed herein can be made from any suitable flexible material, for example, cardboard, veneer, reinforced paper, plastic sheet, silicon, and like material known in the art for use in the manufacturing of the greeting cards. Preferably the sheet can be a single sheet of card stock paper that is scored. The sheet can be also be produced in assorted colors and sizes. Additionally, FIG. 1 shows the first panel and the second panel of the same sizes, however the first panel can be of a smaller size than the second panel for aesthetic purposes. Furthermore, the two panels can be dye-cut at edges for enhancing the aesthetic appearance of the gift article. Each the first panel and the second-panel are having an inner face and an external face. The inner faces of each the first panel and the second panel faces each other.

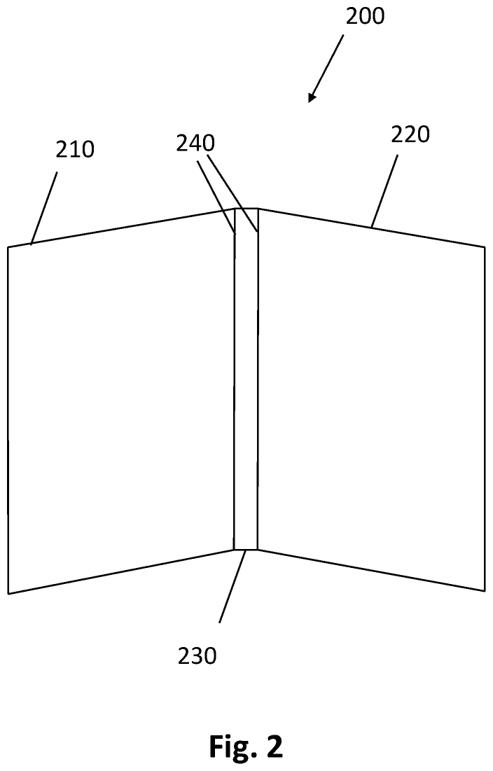

FIG. 2 shows an alternate implementation of the two panels. FIG. 2 shows a first panel 210 and a second panel 220 separated by a margin 230. Two spaced-apart traversing fold lines 240 separate the sheet 200 into three foldable sections i.e. the first panel, the second panel, and the margin. The width of the margin can be proportional to the size of the gift that can be carried by the gift article. Additionally, the gift article disclosed herein can include a number of the intermediate panels attached to the fold line or the margin, as the case may be.

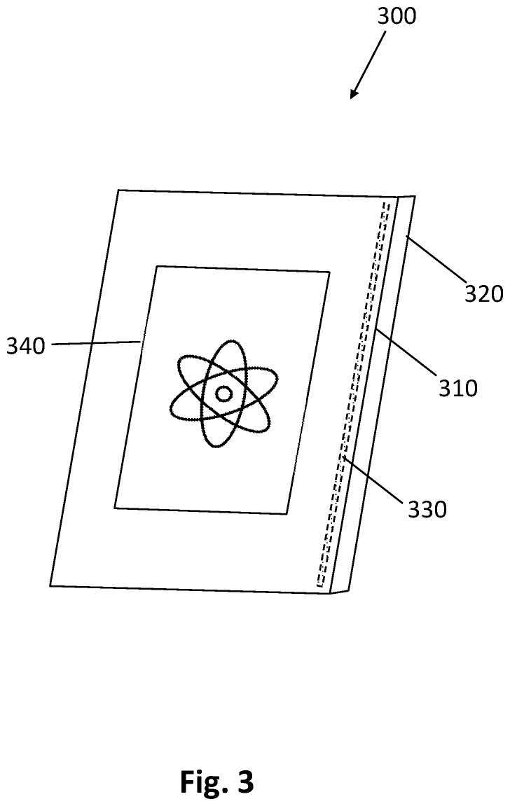

FIG. 3 shows one implementation of a gift holder 300 that can be attached to the inner face of the first panel. The gift holder 300 is in the form of a flexible pouch or bag that can be removably attached to the inner surface of the first panel. The gift holder is shown in FIG. 3 is rectangular having the three sides closed while the fourth side 310 is open which acts as an opening for the gift holder. The opening can be provided with a fastener for closing the gift holder. The fastener can be of a permanent type or reusable. For example, the fastener can be a heat-curable adhesive that bonds the two opposite walls of the pouch. One wall of the pouch can be provided with a flap 320 that extends from the edge of the wall of the pouch. The flap can be configured with a fastener. For example, an adhesive liner traversing the length of the flap can be configured. Alternatively, the fastener can be provided on the wall of the pouch such as the fastener 330 shown in FIG. 3. The adhesive liner can be protected by a release liner that can be removed to expose the adhesive liner that can be then bonded to the outer surface of the opposite wall of the pouch closing the opening. The heat-cured adhesive is generally permanent, however, the pouch can also be removable closed allowing the disclosed gift article to be reused. For removably closing, the gift holder or pouch, fasteners such as pressure-sensitive adhesive, hook and loop fasteners, zip fasteners, and like can also be used.

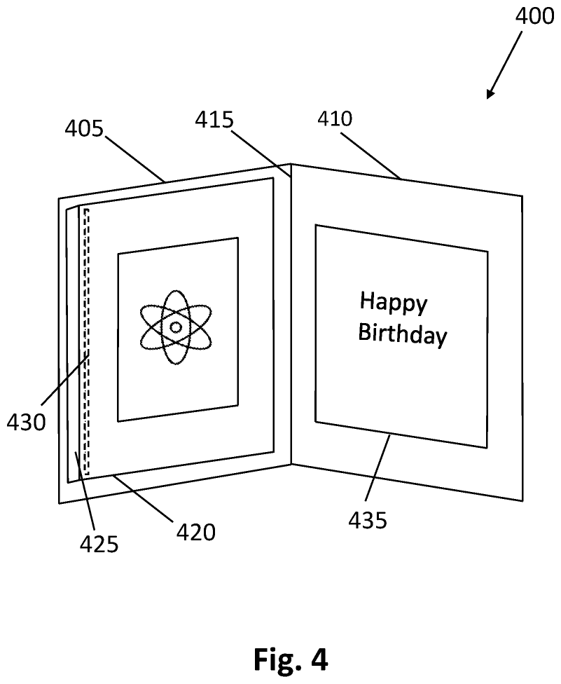

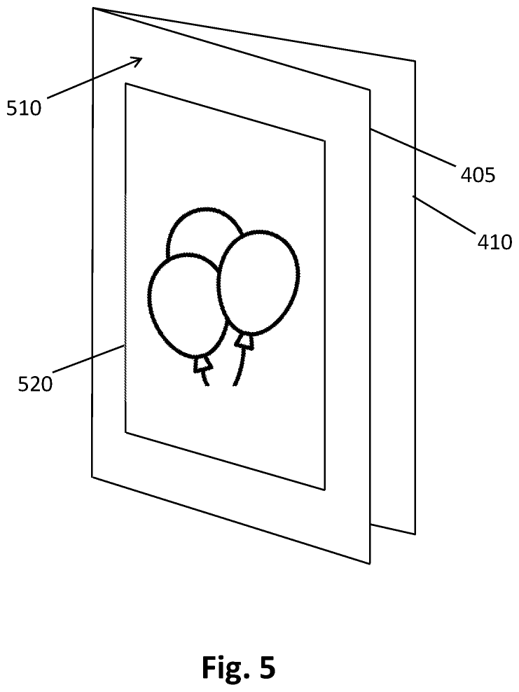

FIG. 4 shows an implementation of the gift holder 400 disclosed herein. The gift holder 400 includes a first panel 405 and a second panel 410 foldably connected along a fold line 415. The first panel and the second panel are continuous and made from a single sheet. Each the first panel and the second panel are having an inner face and an outer face. The inner face of the first panel and the inner face of the second panel are in face-to-face relation. FIG. 4 shows the disclosed gift article in an open position. The first panel 405 is shown to be configured with a gift holder 420 that is attached to the inner face of the first panel 405. The gift holder 420 is having the three closed sides to form a pouch or bag and the remaining one side of the gift holder is open that faces the outer longer edge of the first panel. A gift item can slide into the gift holder through the opening and the gift can be secured by closing the gift holder. The gift holder is shown to have a flap 425 that is configured to attach with a fastener 430 for closing the gift holder. The inner face of the second panel (rear panel) is having a message section 435 that can be used to provide a message including an illustration, photograph, artwork, words, or a combination thereof. FIG. 5 shows the outer face 510 of the first panel 405 of the gift article. The outer face 510 is having a second message section 520 that may also include illustration, photograph, artwork, words, or a combination thereof.

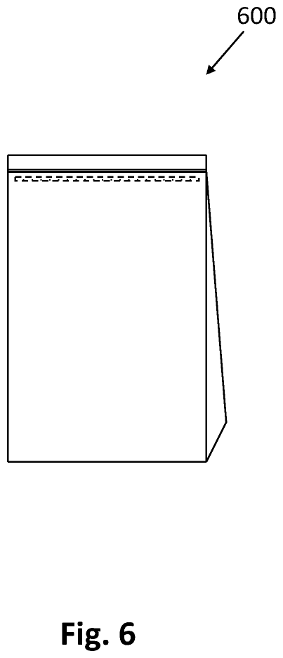

The gift holder as shown in FIG. 4 is of an envelope like configuration that is attached to the inner face of the first panel. However, the gift holder can be of any other shape, for example, the gift holder can be configured as a gusset pouch. An implementation of the gusset pouch 600 can be seen in FIG. 6 that when embodied into the disclosed gift holder allows the gift holder to carry a bigger size gift item. Additionally, FIG. 4 shows the gift holder attached to the inner face of the first panel, however, the position of the gift holder can be varied without departing from the scope of the present invention. In one case, the gift holder can be attached to the outer face of the second panel. In another case, the gift holder can be attached to the inner surface of the second panel Also, in case the gift article is having multiple intermediate panels, the gift holder can be attached to any of the intermediate panels. Additionally, the gift holder can also be formed by two adjacent intermediate panels. Still, additionally, the gift holder can be formed by the first panel and the adjacent intermediate panel. When two panels are joined to form the gift holder, the three edges of the panels can be bonded to form a closed envelope like configuration. The fourth open side can be provided with a fastener. The exposed face of the gift holder can also include a third message section 340 (shown in FIG. 3) that can include an illustration, photograph, artwork, words, or a combination thereof.

The preferred embodiment provides a means to allow the giver the versatility of the size, shape, and type of gift item that can fit inside the gift holder and a greeting card in an all-in-one design to be given to an intended receiver. The gift article disclosed herein provides for quick and easy giving and receiving a gift wherein the gift holder allows a way to seal, secure, and conceal the gift item, such as baked cookies, candies, jewelry, and the like gift items that can fit into the gift holder. Any food or non-food gift items can be gifted with a suitable gift holder, wherein the gift holder can be made available in a variety of sizes for securing a variety of fixed dimensional items in an easily used construction. The giver opens the gift holder slides a gift item into the gift holder, wherein the gift holder also allows a bulky gift item to be carried. The receiver opens the greeting card with a surprise gift inside the gift holder, that may be removed, wherein the gift holder as such can be separated and reused.

The gift holder in the configuration of a pouch or a bag can be resealable and reusable. The pouch can have a dual-track zipper. For gifting any food item, the pouch can be made of food-grade material that is approved for storing food items. It is also obvious that the pouch can be made of different specifications for different kinds of gift articles. Also, it is preferable that the pouch is reusable, but the pouch can also be made disposable. For example, the pouch can be heat sealed such that the gift item can only be taken out by tearing of the pouch. In such a case, a line of weakness can also be provided that can be torn to remove the gift item. The pouch or bags can be medical-grade bags, slider bags, zip bags, locking zipper bags, child-proof bags, flap closure, smell-proof and odor-free bags, food storage bags, double-zipper sandwich bags, freezer bags, food fresh bag, cooking seal bag, exit bags, mylar bags, pouch style bags, airtight and tight-locking seal bags, plastic bags, eco-friendly bags, vinyl bags, recyclable bags, hemp bags, fabric bags, silicone bags, plastic bags, cardboard bags, paper bags and the like.

In one implementation, the greeting card can be of a 10 by 7 inch scored card having the pouch of about 5 by 7-inch size. The disclosed gift article can be manufactured in a range of sizes having the greeting cards as small as 4″×6″ and as large as 2′×3′ jumbo greeting card. The gift article can include additional advantages of the combined greeting card and the gift holder, wherein the gift holder is configured as a pouch or bag that is removable and reusable by the receiver. The gift holder can be attached using a synthetic rubber bond that is easily removable without leaving a sticky residue on the greeting card. The one or more design sections on the gift articles can be replaced by different design sections. The gift holder can be removably or fixedly coupled to the greeting card. For removably coupling the gift holder to the greeting card, a variety of coupling elements may be used, such as hook and loop fasteners, double-sided tape, adhesive, die-cut out slits, slide tracks, and like. Alternatively, the gift holder can be attached to the greeting card with an elastic strap. The elastic strap can have ornamental decorations, such as a bow. The elastic strap can be easily removed by the user for detaching the gift holder from the greeting card.

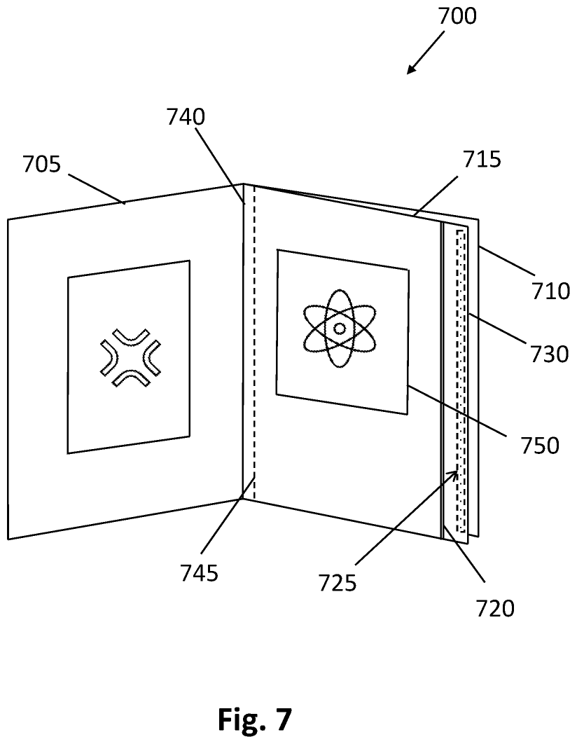

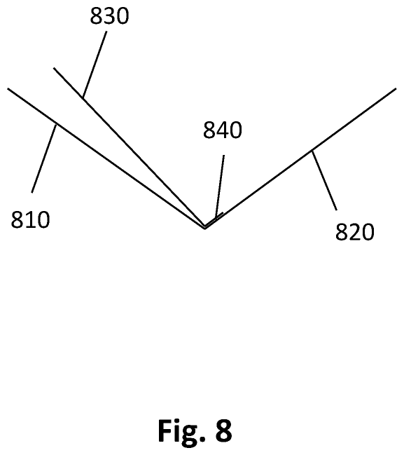

In one embodiment, the gift article can be having a number of intermediate panels and at least one intermediate panel can be configured as the pouch. FIG. 7 shows the gift article 700 having a front panel 705, a rear panel 710, and an intermediate panel 715. The intermediate panel 715 is configured as a pouch having three sides closed and one side open for receiving a gift item. The open side 720 is also having a fastener 725 for closing the opening. The fastener 725 is configured on a flap 730 that extends from an edge of the wall of the pouch. The intermediate panel 715 is attached to the fold line 740. Also, it can be seen in FIG. 7 is a line of weakness 745 traversing the intermediate panel 715 near the fold line 740, wherein the line of weakness runs parallel to the fold line. The line of weakness 745 shown in FIG. 7 is having spaced perforations along which the gift holder can be easily torn. The line of weakness allows the intermediate panel, which is also the gift holder, to be separated from the greeting card. The gift article can have several intermediate panels of which at least one can be configured as the gift holder. The intermediate panels, including the intermediate panel configured as a gift holder, can have design/message sections on one or both faces. FIG. 7 shows the intermediate panel 715 has a design section 750 that included an image. As explained before the design or message section can have images, artwork, words, and like. The intermediate panel can also be removably attached to the fold line. One such implementation is shown in FIG. 8 which shows the front panel 810, a rear panel 820, and an intermediate panel 830. The intermediate panel is folded near the edge to form a flange 840, wherein the flange 840 is removably attached to the rear panel 820.

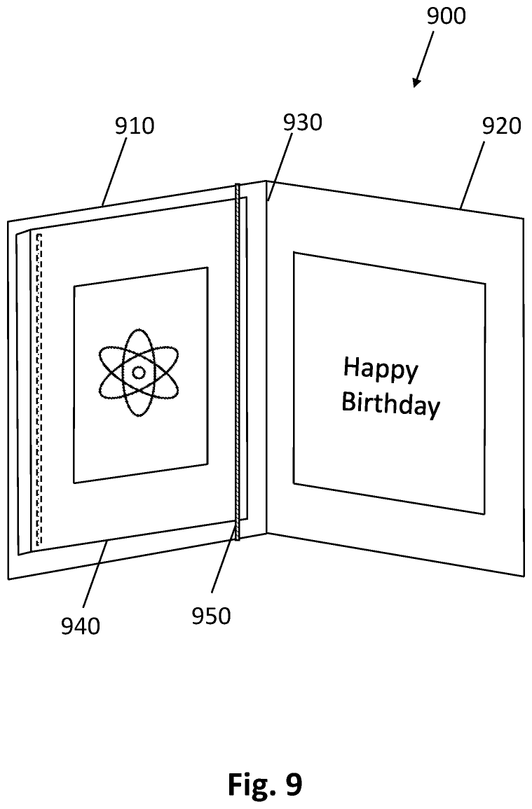

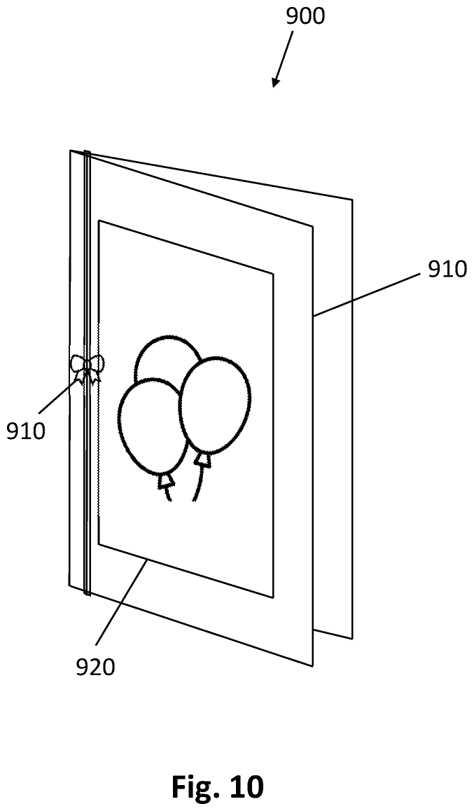

FIG. 9 shows the gift article 900 having a front panel 910, a rear panel 920, a fold line 930 connecting the front panel and the rear panel, a gift holder 940, and an elastic band 950. The elastic band 950 attaches the gift holder 940 to the front panel and be of aesthetic construction. FIG. 10 is the front view of the gift article 900 showing the elastic band having a bow 910 to further enhance the aesthetic appearance. The outer face of the first panel 910 is also having a design/message section 920.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A gift article comprising:
a front panel, the front panel having an outer face and an inner face;
a rear panel, the rear panel having an outer face and an inner face, the front panel and the rear panel having a common edge, the common edge configured as a fold line permitting the folding of the first panel against the second panel; and
a gift holder, the gift holder having a front wall and a rear wall, the front wall and the rear wall having at least three edges bonded to form an enclosure, the enclosure having an opening for receiving a gift item, the opening is configured with a fastener for closing access into interior of the enclosure through the opening.

2. The gift article of claim 1, wherein the gift holder is of a flexible bag configuration that is removably attached to the inner face of the front panel, wherein the rear wall of the gift holder attaches to the inner face of the front wall.

3. The gift article of claim 2, wherein the gift holder further comprises a design section interchangeably coupled to an outer surface of the front wall of the gift holder.

4. The gift article of claim 2, wherein the gift holder is a gusset bag.

5. The gift article of claim 1, wherein the gift holder is configured as an intermediate panel, the intermediate panel having one edge of the three closed edges extended to form a flange, the flange attached to the fold line, a line of weakness is configured in the flange, the line of weakness runs parallel to the fold line along the length of the flange, the intermediate panel is sandwiched between the front panel and the rear panel, the intermediate panel configured to be torn along the line of weakness.

6. The gift article of claim 5, wherein the line of weakness is spaced perforations.

7. The gift article of claim 5, wherein the intermediate panel is having a first side and an opposite second side, each the first side and the second side of the intermediate panel are having removable design sections.

8. The gift article of claim 5, wherein the gift article further comprises one or more intermediate panels attached to the fold line, each the one or more intermediate panels having at least one design section.

9. The gift article of claim 5, wherein each the inner face of the rear panel, the outer face of the front panel, and the inner face of the front panel are having design sections.

10. The gift article of claim 1, wherein the gift holder is configured as an intermediate panel, the intermediate panel having one edge of the three closed edges extended to form a flange, the flange removably attached to the fold line and the rear panel, wherein the intermediate panel is sandwiched between the front panel and the rear panel.
